(19) United States
(12) Patent Application Publication
(10) Pub. No.: US 2007/0209010 A1
(43) Pub. Date: Sep. 6, 2007

(54) Computer implemented systems and methods for testing the usability of a software application

(75) Inventor: Ryan T. West, Holly Springs, NC (US)

Correspondence Address: PATENT GROUP 2N;JONES DAY, NORTH POINT, 901 LAKESIDE AVENUE, CLEVELAND, OH, 44114, US

(73) Assignee: SAS Institute Inc.

(21) Appl. No.: 11/365,649

(22) Filed: Mar. 1, 2006

(51) Int. Cl. G06F 3/00

(52) U.S. Cl. 715/762

(57) ABSTRACT

In accordance with the teachings described herein, systems and methods are provided for testing the usability of a software application. A test interface may be provided that executes independently of the software application under test. A task may be assigned via the test interface that identifies one or more operations to be performed using the software application under test. One or more inputs may be received via the test interface to determine if the task was performed successfully.

### FIELD

The technology described in this patent document relates generally to software performance analysis. More specifically, computer-implemented systems and methods are provided for testing the usability of a software application.

### BACKGROUND AND SUMMARY

Usability testing relates generally to the process of collecting human performance data on the task workflow and user interface design for a software application. The goal of usability testing is often to determine user problem areas in the software interface before the product is released and to set human performance benchmarks for assessing productivity improvements in the software over time. In a typical usability study, a user sits in front of a designated computer and is given a list of tasks to try to perform with the software package being studied. The study facilitator observes the participant as he or she attempts to complete the task and makes performance measurements. Performance measurements may, for example, be based on the time it takes the participant to complete the task, whether the task is completed successfully, the number and nature of errors made by the user, and/or other data. Based on these observed performance measures, problem areas in the user interface or task workflow are identified and recommendations are made for usability improvements. This type of study, however, is typically time intensive for the usability engineers and is limited in the number of studies that can feasibly be performed for each software application.

In accordance with the teachings described herein, systems and methods are provided for testing the usability of a software application. A test interface may be provided that executes independently of the software application under test. A task may be assigned via the test interface that identifies one or more operations to be performed using the software application under test. One or more inputs may be received via the test interface to determine if the task was performed successfully.

### BRIEF DESCRIPTION OF THE DRAWINGS

FIG. 1 is a block diagram depicting an example system for testing the usability of a software application.

FIG. 2 is a block diagram depicting an example system for testing the usability of a plurality of software applications.

FIG. 3 is a block diagram depicting an example usability testing system in a network environment.

FIG. 4 depicts a system configuration in which the usability testing program is located on the same computer as the software application under test.

FIG. 5 is a flow diagram depicting an example method for performing an automated usability study for a software application.

FIG. 6 is a diagram illustrating examples of a test interface for an automated usability testing system.

FIG. 7 is a flow diagram depicting an example method for testing the usability of a software application.

FIGS. 8-13 depict an example test interface for an automated usability testing system.

### DETAILED DESCRIPTION

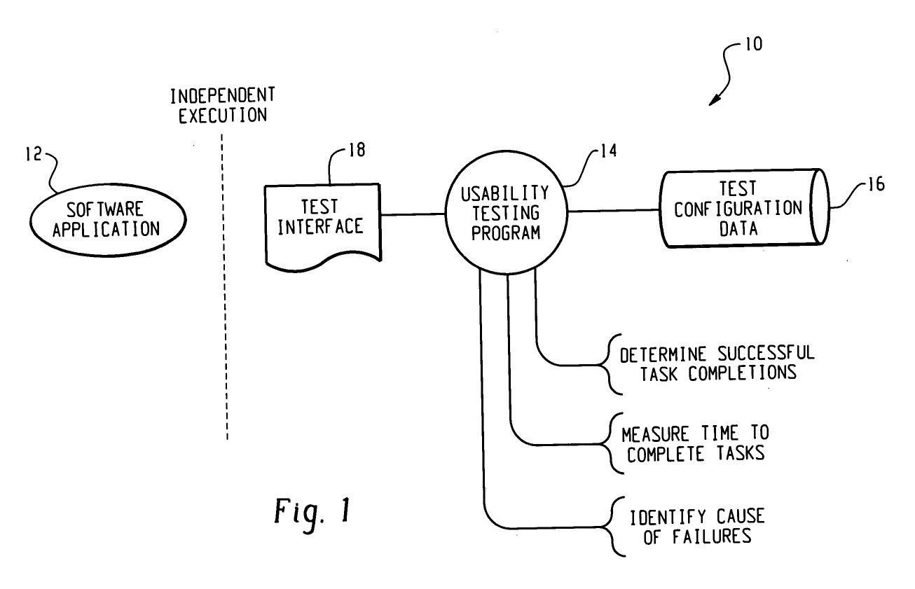

FIG. 1 is a block diagram depicting an example automated usability testing system 10 for testing the usability of a software application 12. The system 10 includes a usability testing program 14 that executes independently of the software application 12 under test. The usability testing program 14 accesses test configuration data 16 and generates a test interface 18. The test configuration data 16 is specific to the software application 12 under test, and is used by the usability testing program 14 to generate the test interface 18. The test configuration data 16 may, for example, be configured by one or more persons facilitating a usability study for the software application 12. The test interface 18 is accessible by the test participant, but executes independently of the software application 12. For example, the test interface 18 may be accessible over a computer network, such as the Internet or a company intranet. In this manner, the test interface 18 may be provided to numerous test participants to perform large-scale usability testing of the software application 12.

In operation, the usability testing program 14 presents one or more tasks via the test interface 18 which are to be performed by the test participant in order to evaluate usability. The test interface 18 then receives input to determine whether the tasks were completed successfully. For example, the test interface 18 may present a question that can be answered upon successful completion of a task, and then receive an input with the answer to the question to determine if the task was successfully completed. The test interface 18 may also provide the test participant with an input for indicating that the task could not be successfully performed and possibly for identifying the cause of the failed performance. In another example, the test interface 18 may provide one or more inputs for determining the time that it takes to complete each task. For example, the time for completing a task may be measured by requiring the test participant to enter a first input (e.g., click on a first button) in the test interface 18 before beginning the task and entering a second input (e.g., click on a second button) when the task is completed, with the usability testing program 14 recording time stamp data when each input is entered. Additional inputs to the test interface 18 may also be provided to collect other usability data and/or user feedback.

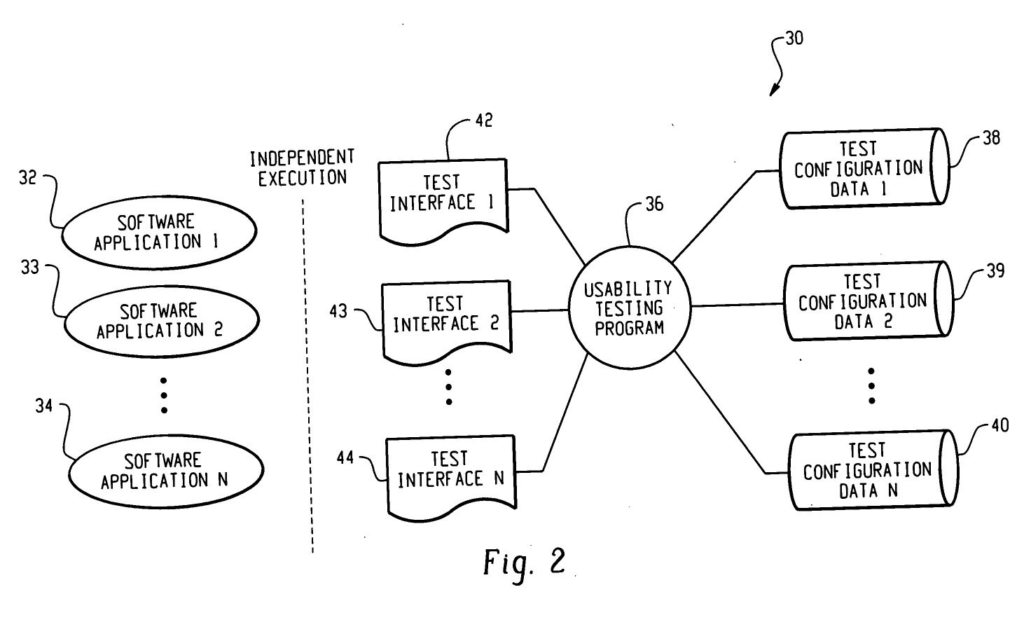

FIG. 2 is a block diagram depicting an example automated usability testing system 30 for testing the usability of a plurality of software applications 32-34. FIG. 2 illustrates that the usability testing program 36 may be used to perform simultaneous usability studies on multiple software applications 32-34. In order to facilitate multiple studies, the testing system 30 may include a plurality of test configuration data stores 38-40, which are used by the usability testing program 36 to generate a test interface 42-44 specific to each software application 32-34 under test. The test interfaces 42-44 execute independently of the software applications 32-34, and may be accessed by numerous test participants, for example over a computer network. In this manner, a large number of studies may be conducted simultaneously in a cost-effective manner, with each study including a broad base of participants.

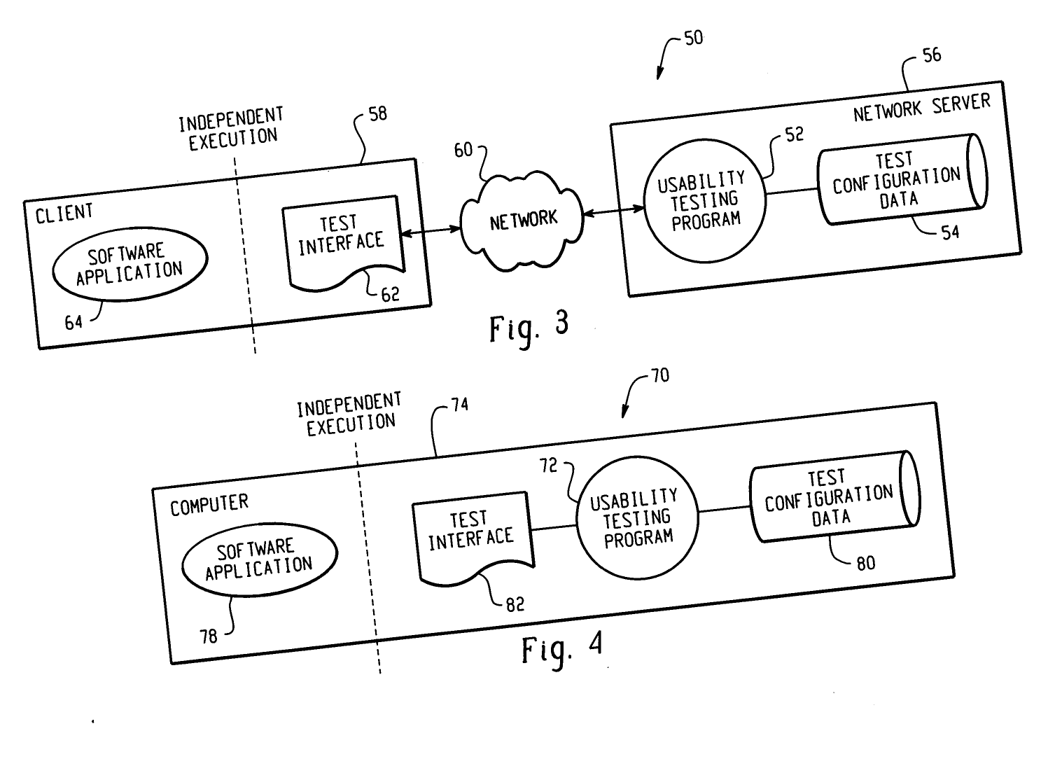

FIG. 3 is a block diagram depicting an example automated usability testing system 50 in a network environment. As illustrated, the usability testing program 52 and test configuration data stores 54 may be located on a first computer 56 or set of computers (e.g., a network server), which is configured to communicate with a second computer 58 (e.g., a network client) over a computer network 60. Using this configuration, the usability testing program 52 may be accessed via the computer network 60 to display the test interface 62 on the second computer 58 along with the software application 64 under test. For example, the usability testing program may be a web-based application and the test interface 62 may be displayed using a web browser application executing on the second computer 58.

FIG. 4 depicts a system configuration 70 in which the usability testing program 72 is located on the same computer 74 as the software application 76 under test. The usability testing program 72 and test configuration data 80 may, for example, be installed along with the software application 78 on one or more isolated computers 74 used for usability testing. In another example, the usability testing program 72 may be loaded onto multiple computers within an organization and the test configuration data 80 may be loaded to the computers (e.g., over a computer network) to configure the usability testing program 72 to generate a test interface 82 for a specific software application 78. In this manner, the usability testing program 72 could be used to test multiple software applications within the organization by loading different test configuration data 80. The usability testing program 72 and test interface 82, although operating on the same computer in this example, execute independent of the software application 78 under test.

FIG. 5 is a flow diagram depicting an example method 90 for performing an automated usability study for a software application. The method begins at step 92. At step 94, an introduction is presented to a test participant, for example using a test interface that executes independent of the software application under test. The introduction may describe the purpose of the usability study and provide instructions to the participant. At step 96, participant training information is presented to the test participant. The participant training information may, for example, be in the form of one or more practice tasks to familiarize the participant with the testing system.

The usability study is performed at step 98. The usability study may require the participant to complete one or more identified tasks using the software application under test and provide information relating to the performance of the tasks via a test interface. The information provided by the participant may be recorded for use in assessing the usability of the software application under test. Upon completion of the usability study, a survey may be presented to the test participant at step 100. The survey may, for example, be used to acquire additional information from the test participant regarding software usability, user satisfaction, demographics, task priority, and/or other information. The method then ends at step 102.

It should be understood that similar to the other processing flows described herein, one or more of the steps and the order in the flowchart may be altered, deleted, modified and/or augmented and still achieve the desired outcome.

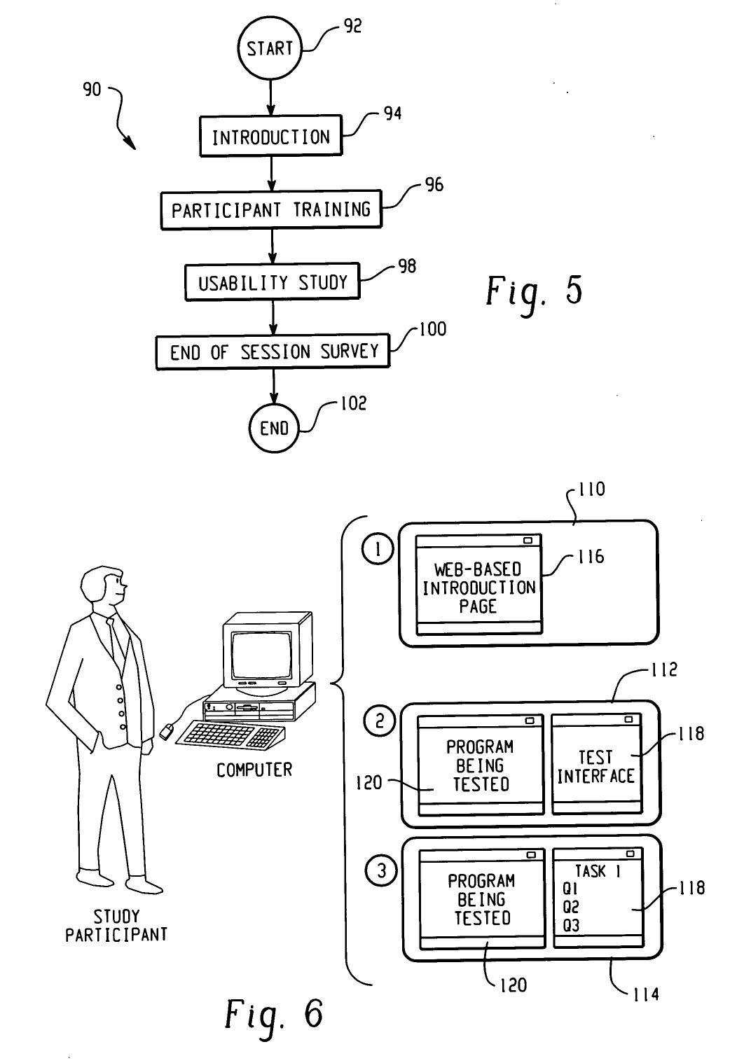

FIG. 6 is a diagram illustrating examples of a test interface for an automated usability testing system. The diagram illustrates three examples 110, 112, 114 of software interfaces that may appear on a test participant's computer screen during a usability test. The first example 110 depicts a test introduction displayed within a web browser interface 116. The usability test may, for example, be initiated via a network connection (e.g., by accessing a web site), and the introduction page 116 may be displayed on the web browser upon initiating the test. The introduction page 116 may, for example, describe the intent of the study, the software application being tested, and an overview of the test interface.

The second example 112 depicts the test interface 118 displayed on the computer screen next to an interface 120 for the software application under test. In this example, the test interface 118 appears on the computer screen as a tall, thin column alongside the application window 120, enabling the test participant to simultaneously view both the test interface 118 and the application window 120. The arrangement of the test interface 1 18 on the computer screen with respect to the application window may, for example, be automatically performed by the usability testing program, but could be performed manually in other examples. As illustrated in the third example 114, the usability testing information is provided to the test participant via the test interface 118, which executes independently of the software application 120 under test.

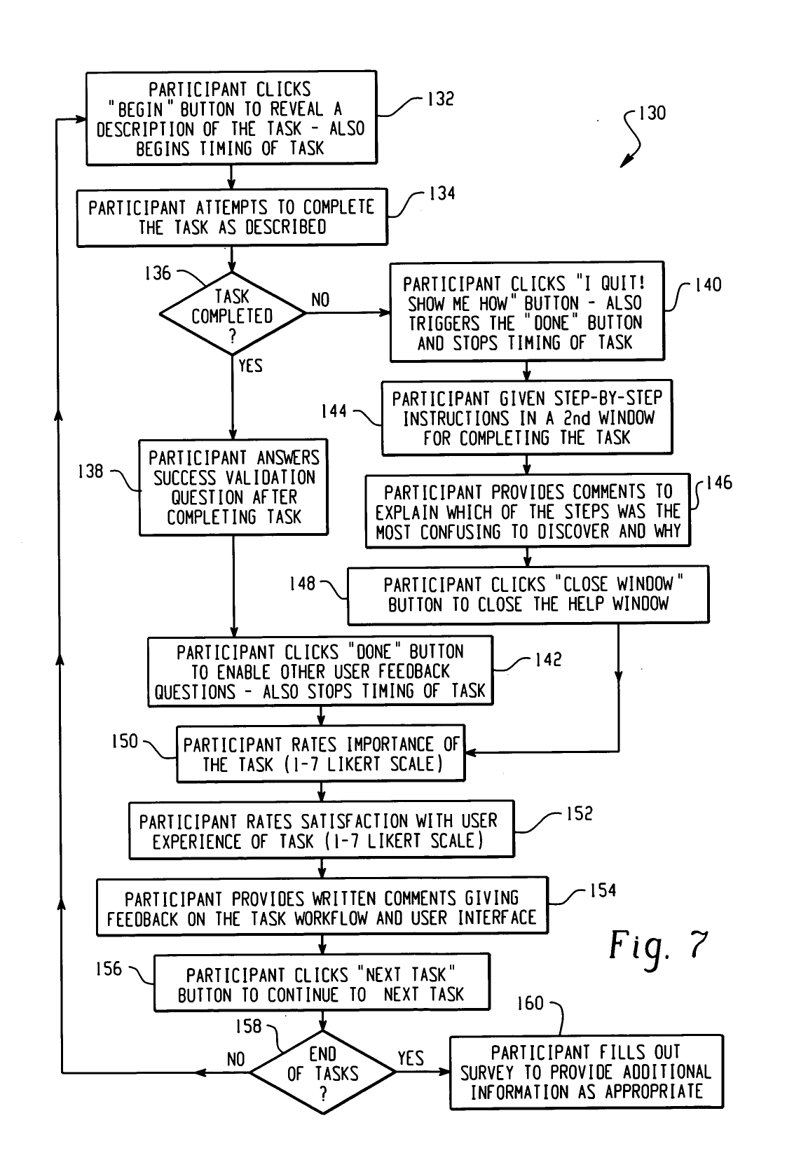

FIG. 7 is a flow diagram depicting an example method 130 for testing the usability of a software application. In step 132, a begin task input (e.g., clicks on a “Begin” button) is received from the test participant to reveal a description of a first task to be performed using the software application under test. The begin task input also causes the method to begin timing the amount of time that it takes the test participant to complete the task. For example, time stamp data may be recorded when the test participant clicks on a “Begin” button to mark the time that the task is started. The test participant then attempts to complete the task using the software application under test at step 134. At decision step 136, if the task is successfully completed, then the method proceeds to step 138. Else, if the task cannot be completed by the test participant, then the method proceeds to step 140.

Upon successfully completing the assigned task, an answer to a validation question is received from the test participant at step 138. The validation question is presented to the user to verify successful completion of the task. For example, the validation question may request an input, such as a data value or other output of the software application, which can only be determined by completing the task. After the answer to the validation question is input, the test participant enters a task completion input (e.g., clicks on a “Done” button) at step 142 to indicate that the task is completed and to stop measuring the amount of time taken to complete the task. For example, if a first time stamp is recorded when the test participant clicks on a “Begin” button and a second time stamp is recorded when the test participant clicks on a “Done” button, then the first and second time stamps may be compared to determine the amount of time taken by the test participant to complete the assigned task. Once the task completion input is received, the method proceeds to step 150.

If the test participant is unable to complete the assigned task, then a task failure input (e.g., an “I quit” button) is entered at step 140. The task failure input causes the method to stop measuring the amount of time taken on the task (e.g., by recording a second time stamp), and step-by-step instructions for completing the task are presented to the participant at step 144. The step-by-step instructions may be presented in an additional user interface window. After reviewing the step-by-step instructions, the test participant inputs one or more comments at step 146 to indicate which one or more steps in the task caused the difficulty. At step 148, the test participant closes the additional window with the step-by-step instructions, and the method proceeds to step 150.

At step 150, an input is received from the test participant to indicate the perceived importance of the task, for example using a seven point Likert scale. Another input is then received from the test participant at step 152 to rate the test participant's satisfaction with the user experience of the task, for example using a seven point Likert scale. At step 154, a textual input is received from the test participant to provide comments, for example regarding the task workflow and user interface. A next task input is then received from the test participant (e.g., by clicking a “next task” button) at step 156, and the method proceeds to decision step 158. If additional tasks are included in the usability test, then the method returns to step 132 and repeats for the next task. Otherwise, if there are no additional tasks, then the method proceeds to step 160. At step 160, a final input may be received from the test participant before the test concludes, for example the participant may fill out an end of session survey.

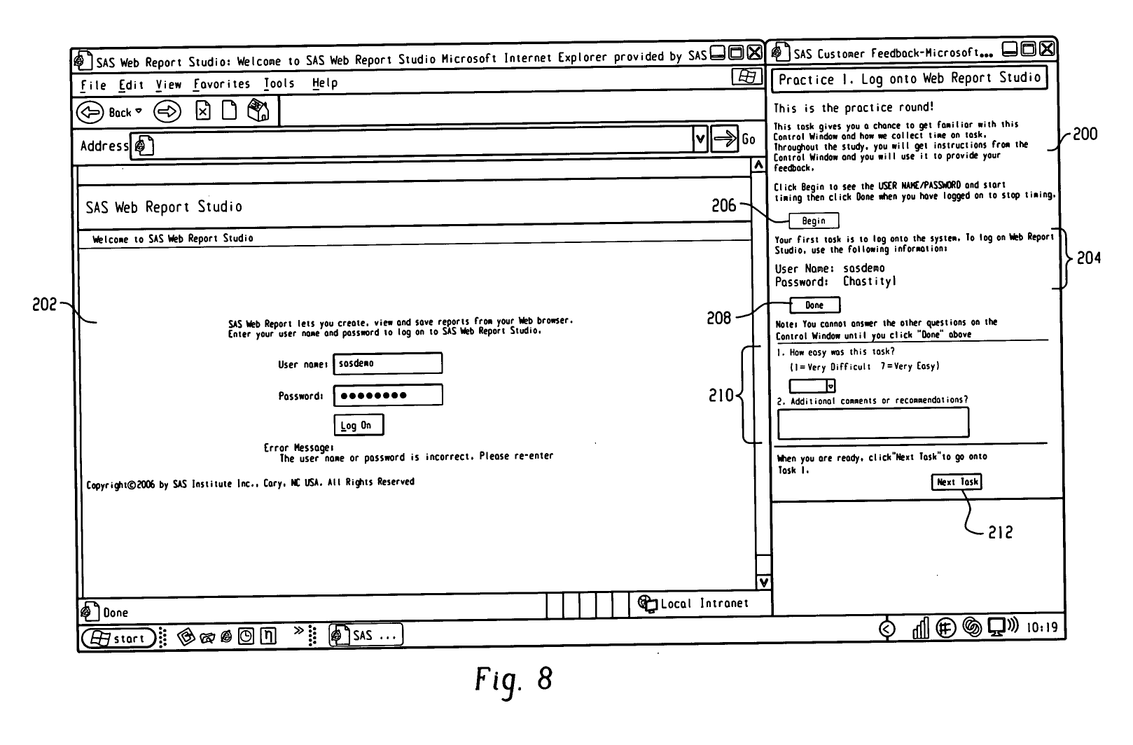

FIGS. 8-13 depict an example test interface for an automated usability testing system. The test interface is generated by a usability testing program, which executes independently of the software application under test. For example, the testing system has no programmatic interaction with the software application under test, nor does it require the collection of system events or event logging from the operating system. Rather, the usability testing program records information entered by the test participant within the test interface. Because of this separation between the software application under test and the testing system, the usability testing system may be used to conduct automated studies on web or desktop applications without the need to install monitoring software on the participant's computer. In this manner, the usability testing system may be used to perform large-scale testing and to improve the reliability of measures beyond that possible in a typical quality lab environment.

With reference first to FIG. 8, the example test interface 200 and the software application 202 under test are displayed side-by-side in two windows on a computer screen. Within the example test interface 200, the testing system has displayed a practice task 204 to enable the test participant to become familiar with the test interface 200 and the usability testing process. In the illustrated example, the practice task 204 requires the test participant to log into the software application 202 under test using the displayed user name and password. Before beginning the displayed task 204, the test participant clicks on a begin task input 206, which begins measuring the amount of time taken to perform the assigned task 204. The begin task input 206 may, for example, cause the usability testing system to record timestamp data to indicate the time that the test participant began performing the assigned task. When the task is completed, the test participant clicks on a task completion input 208. The task completion input 208 may, for example, cause the usability testing system to record timestamp data to indicate the time that the test participant finished performing the task. In addition, the task completion input 208 may cause the test interface 200 to display the next step in the usability test. For instance, in the illustrated example, survey questions and survey input fields 210 are displayed after the task completion input 208 is entered. When the practice task 204 is completed and the survey information 210 is entered, the test participant may proceed to the first task in the usability test by pressing the “next task” input 212.

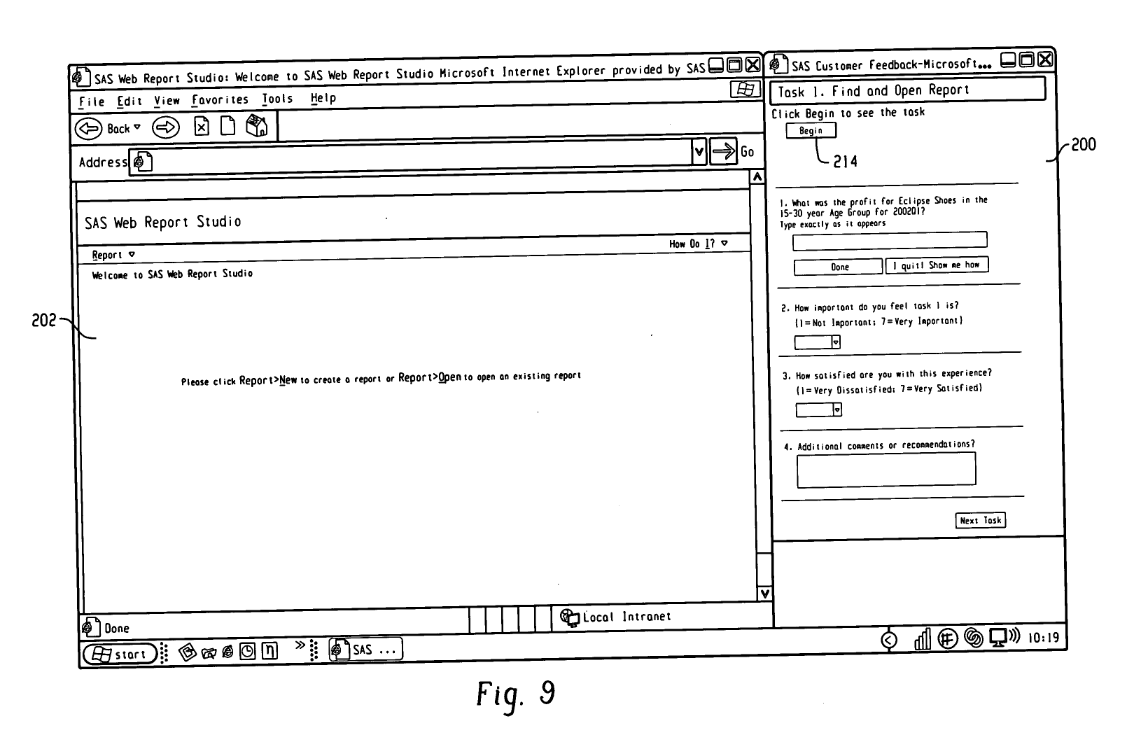

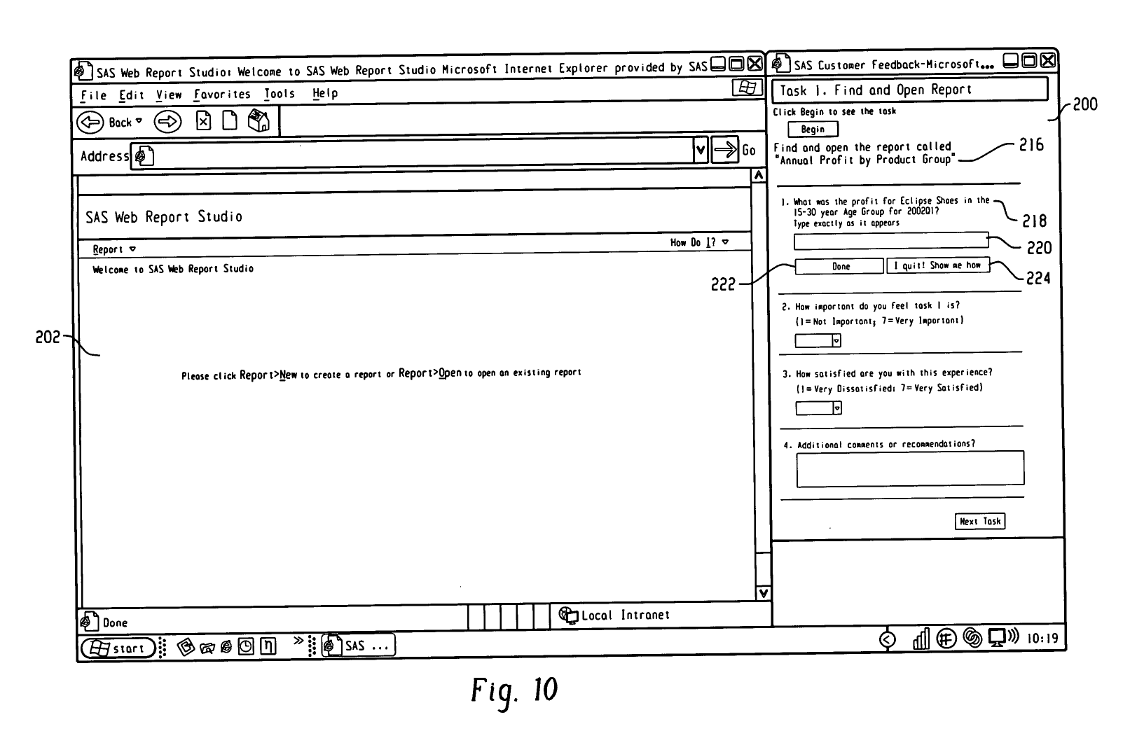

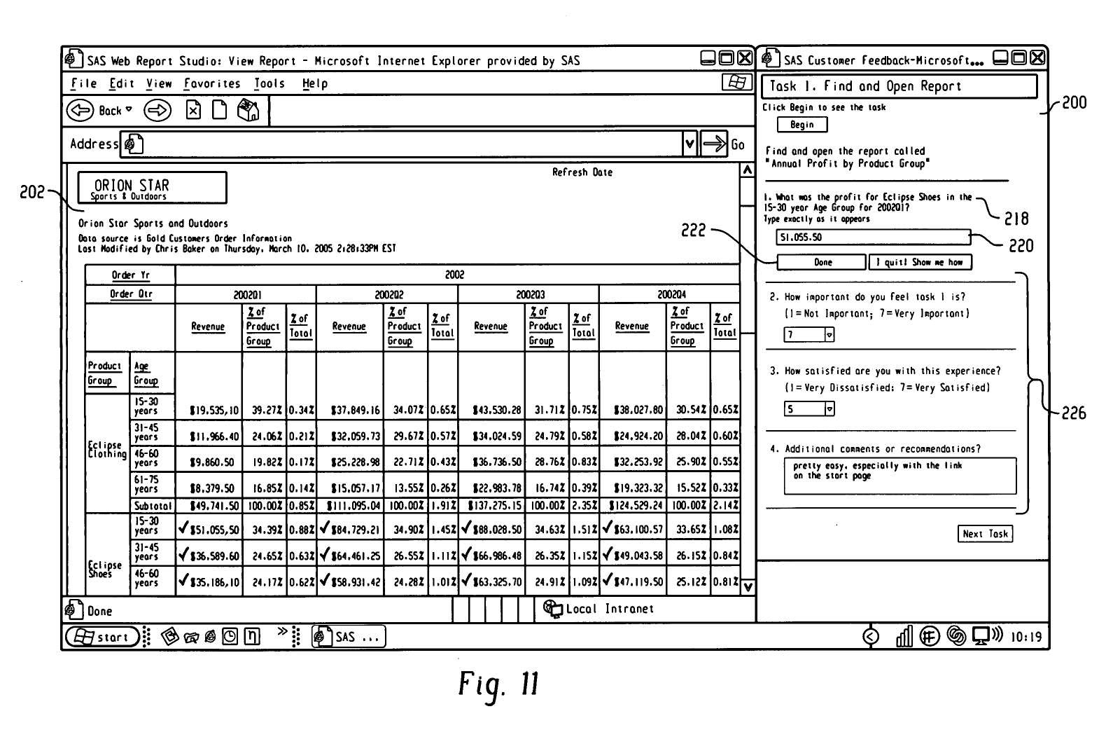

FIG. 9 illustrates the beginning of the first task in the example usability test. To begin the task, the test participant clicks on the begin task input 214. The first task 216 is then displayed to the test participant in the test interface 200, as illustrated in FIG. 10. Also displayed in FIG. 10 is a validation question 218 and a validation input field 220 for entering an answer to the validation question 218 upon successful completion of the assigned task. The validation question 218 preferably can only be answered upon successful completion of the assigned task, as illustrated in FIG. 11. For instance, in the illustrated example, the assigned task of finding and opening the report called “Annual Profit by Product Group” must be performed successfully to answer the validation question 218, which relates to a data value within the report. When the assign task is completed and the validation input 220 is entered, the test participant may click on the task completion input 222 to record the time on task and to move onto the next phase of the usability test. For example, FIG. 11 illustrates survey questions and survey input fields 226 that are displayed after the test participant clicks the task completion input 222.

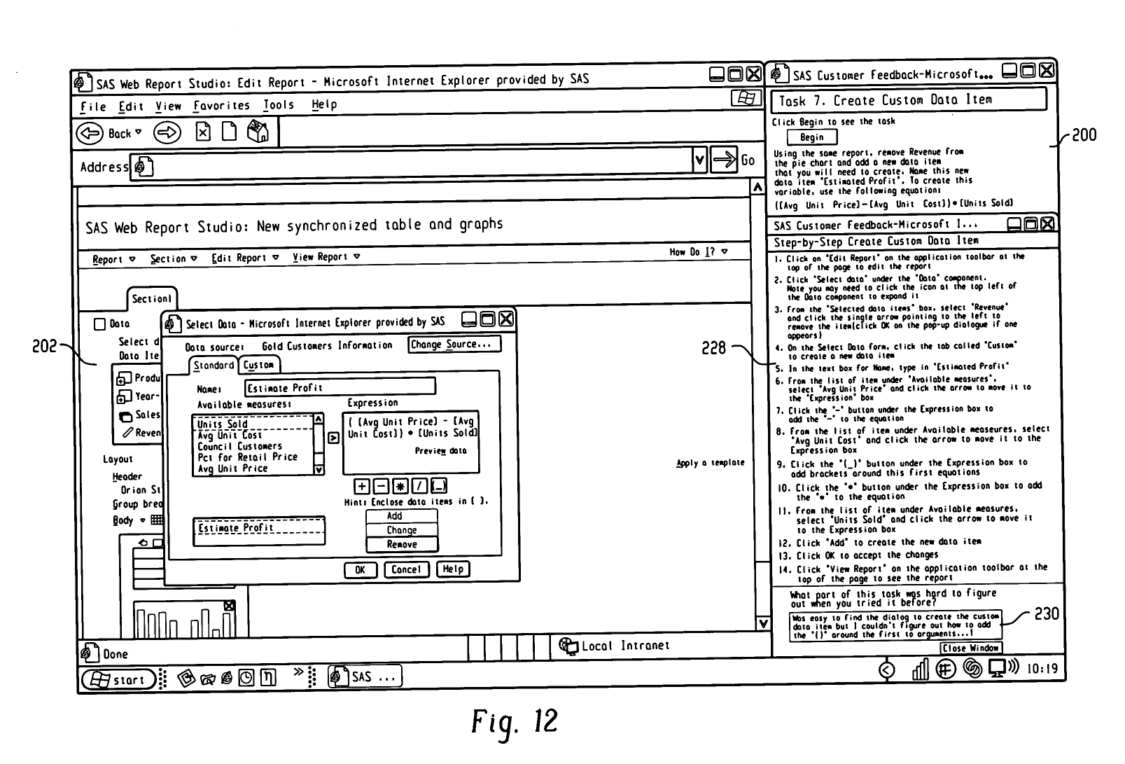

Alternatively, if the test participant is unable to complete the task, he or she may click on the task failure input 224 to end the task and to display step-by-step instructions 228 for performing the task. Example step-by-step instructions are illustrated in FIG. 12. As shown in FIG. 12, the step-by-step instructions may be displayed in a separate window from the test interface 200. The reason or reasons that the task could not be performed successfully will typically be evident to the test participant once the step-by-step instructions are reviewed. The instruction window 228 may, therefore, also include a field 230 for inputting information indicating one or more reasons why the task was not successfully performed.

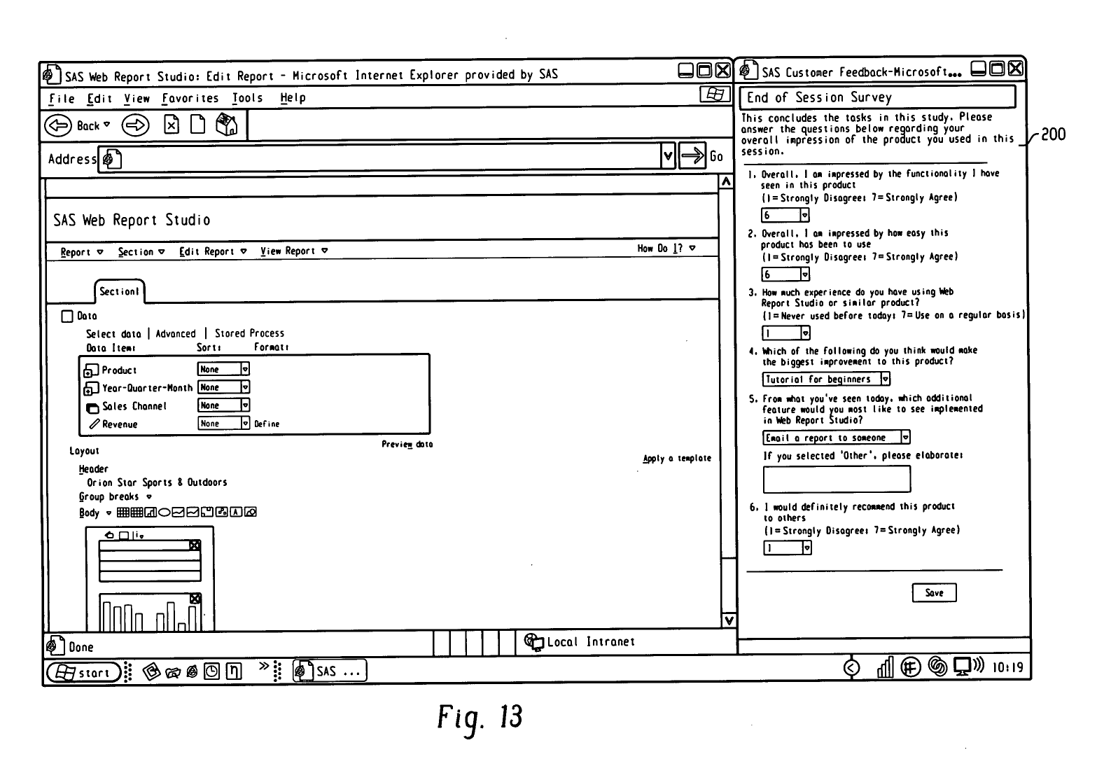

After the usability test is completed, the test interface 200 may display one or more additional survey questions, as illustrated in the example of FIG. 13.

This written description uses examples to disclose the invention, including the best mode, and also to enable a person skilled in the art to make and use the invention. The patentable scope of the invention may include other examples that occur to those skilled in the art.

It is further noted that the systems and methods described herein may be implemented on various types of computer architectures, such as for example on a single general purpose computer or workstation, or on a networked system, or in a client-server configuration, or in an application service provider configuration.

It is further noted that the systems and methods may include data signals conveyed via networks (e.g., local area network, wide area network, internet, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform methods described herein. Other implementations may also be used, however, such as firmware or even appropriately designed hardware configured to carry out the methods and systems described herein.

The systems' and methods' data (e.g., associations, mappings, etc.) may be stored and implemented in one or more different types of computer-implemented ways, such as different types of storage devices and programming constructs (e.g., data stores, RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It is claimed:

1. A method for testing the usability of a software application, comprising:
providing a test interface that executes independently of the software application under test;
assigning a task via the test interface, the task identifying one or more operations to be performed using the software application under test; and
receiving one or more inputs via the test interface to determine if the task was performed successfully.

2. The method of claim 1, wherein there is no programmatic interaction between the test interface and the software application under test.

3. The method of claim 1, wherein the one or more inputs include a task completion input for indicating that the task has been successfully performed.

4. The method of claim 3, further comprising:
providing a validation question via the test interface, wherein the one or more inputs include an answer to the validation question which verifies that the task was performed successfully.

5. The method of claim 4, wherein the validation question requests data that may be determined upon successful completion of the task, and wherein the answer to the validation question provides the requested data.

6. The method of claim 1, wherein the one or more inputs include a task failure input for indicating that the task has not been successfully performed.

7. The method of claim 6, further comprising:
in response to receiving the task failure input, providing instructions for performing the task.

8. The method of claim 7, further comprising:
receiving an additional input that identifies one or more reasons why the task was not successfully performed.

9. The method of claim 8, wherein the additional input identifies which one or more of the task operations resulted in the task not being successfully performed.

10. The method of claim 1, further comprising:
receiving a begin task input via the test interface indicating a start of the task;
receiving an end task input via the test interface indicating an end of the task; and
determining an amount of time spent on the task based on the begin task input and the end task input.

11. The method of claim 10, wherein the end task input is a task completion input indicating that the task was successfully performed.

12. The method of claim 10, wherein the end task input is a task failure input indicating that the task was not successfully performed.

13. The method of claim 1, wherein the test interface is provided over a computer network.

14. The method of claim 13, wherein the test interface is a web-based application.

15. The method of claim 14, wherein the software application under test is not web-based.

16. The method of claim 1, wherein the test interface is provided by a testing software application, the testing software application and the application under test executing on the same computer.

17. An automated usability testing system, comprising:
a usability testing program that provides a test interface for use in testing the usability of a software application, the usability testing program being configured to execute independently of the software application under test;
the usability testing program being configured to display a task via the test interface, the task identifying one or more operations to be performed using the software application under test; and
the usability testing program being further configured to receive one or more inputs via the test interface to determine if the task was performed successfully.

18. The automated usability testing system of claim 17, wherein there is no programmatic interaction between the usability testing program or the test interface and the software application under test.

19. The automated usability testing system of claim 18, wherein the usability testing program does not receive event data recorded in connection with the operation of the software application under test.

20. The automated usability testing system of claim 17, further comprising:
test configuration data stored on a computer readable medium, the test configuration data for use by the usability testing program in displaying the task.

21. The automated usability testing system of claim 17, wherein the usability testing program executes on a first computer and the software application under test executes on a second computer, the first computer being coupled to the second computer via a computer network, and the test interface being displayed on the second computer.

22. The automated usability testing system of claim 17, wherein the usability testing program and the software application under test execute on the same computer.

23. The automated usability testing system of claim 17, wherein the one or more inputs include a task completion input for indicating that the task has been successfully performed.

24. The automated usability testing system of claim 23, wherein the test interface includes a task completion field for inputting the task completion input.

25. The automated usability testing system of claim 24, wherein the task completion field is a graphical button.

26. The automated usability testing system of claim 23, wherein the usability testing program is further configured to provide a validation question via the test interface, wherein the one or more inputs include an answer to the validation question which verifies that the task was performed successfully.

27. The automated usability testing system of claim 26, wherein the test interface includes a textual input field for inputting the answer to the validation question.

28. The automated usability testing system of claim 26, wherein the validation question requests data that may be determined upon successful completion of the task, and wherein the answer to the validation question provides the requested data.

29. The automated usability testing system of claim 17, wherein the one or more inputs include a task failure input for indicating that the task has not been successfully performed.

30. The automated usability testing system of claim 29, wherein the test interface includes a task failure field for inputting the task failure input.

31. The automated usability testing system of claim 30, wherein the task failure field is a graphical button.

32. The automated usability testing system of claim 29, wherein the usability testing program is further configured to display instructions for performing the task in response to receiving the task failure input.

33. The automated usability testing system of claim 32, wherein the instructions are displayed separately from the test interface.

34. The automated usability testing system of claim 32, wherein the usability testing program is further configured to receive an additional input via the test interface to identify one or more reasons why the task was not successfully performed.

35. The automated usability testing system of claim 34, wherein the additional input identifies which one or more of the task operations resulted in the task not being successfully performed.

36. The automated usability testing system of claim 17, wherein the usability testing program is further configured to determine an amount of time spent on the task.

37. The automated usability testing system of claim 36, wherein the usability testing program is further configured to receive a begin task input via the test interface to indicate a start of the task, receive an end task input via the test interface to indicate an end of the task, and determine the amount of time spent on the task based on the begin task input and the end task input.

38. The automated usability testing system of claim 37, wherein the end task input is a task completion input indicating that the task was successfully performed.

39. The automated usability testing system of claim 38, wherein the test interface includes a begin task field for inputting the begin task input and includes a task completion field for inputting the task completion input.

40. The automated usability testing system of claim 39, wherein the begin task field and the task completion field are graphical buttons.

41. The automated usability testing system of claim 37, wherein the end task input is a task failure input indicating that the task was not successfully performed.

42. The automated usability testing system of claim 41, wherein the test interface includes a begin task field for inputting the begin task input and includes a task failure field for inputting the task failure input.

43. The automated usability testing system of claim 42, wherein the begin task field and the task failure field are graphical buttons.

44. The automated usability testing system of claim 17, wherein the usability testing program is configured to provide one or more additional test interfaces for use in testing the usability of one or more additional software applications.

45. The automated usability testing system of claim 44, further comprising:
one or more additional sets of test configuration data stored on one or more computer readable mediums, the additional sets of test configuration data for use by the usability testing program in providing the one or more additional test interfaces, wherein each additional set of test configuration data corresponds to one of the additional software applications under test.

46. A computer-readable medium having a set of software instructions stored thereon, the software instructions comprising:
first software instructions for providing a test interface that executes independently of-the software application under test;
second software instructions for assigning a task via the test interface, the task identifying one or more operations to be performed using the software application under test; and
third software instructions for receiving one or more inputs via the test interface to determine if the task was performed successfully.

47. The computer-readable medium of claim 46, wherein the one or more inputs include a task completion input for indicating that the task has been successfully performed, further comprising:
fourth software instructions for providing a validation question via the test interface, wherein the one or more inputs include an answer to the validation question which verifies that the task was performed successfully.

48. The computer-readable medium of claim 46, wherein the one or more inputs include a task failure input for indicating that the task has not been successfully performed, further comprising:
fourth software instructions for displaying instructions for performing the task in response to receiving the task failure input.

49. The computer-readable medium of claim 48 further comprising:
fifth software instructions for receiving an additional input that identifies one or more reasons why the task was not successfully performed.

50. The computer-readable medium of claim 46, further comprising:
fourth software instructions for receiving a begin task input via the test interface indicating a start of the task;
fifth software instructions for receiving an end task input via the test interface indicating an end of the task; and
sixth software instructions for determining an amount of time spent on the task based on the begin task input and the end task input.
